(19) United States
(12) Patent Application Publication
(10) Pub. No.: US 2024/0351153 A1
(43) Pub. Date: Oct. 24, 2024

(54) AUTOMATIC CORRECTION DEVICE AND METHOD FOR BLADE EDGE POSITION IN MACHINE TOOL

(71) Applicant: NAKAMURA-TOME PRECISION INDUSTRY CO., LTD., Hakusan-shi (JP)

(72) Inventors: Masahiko KAKUMOTO, Hakusan-shi (JP); Satoru Yamamoto, Hakusan-shi (JP)

(73) Assignee: NAKAMURA-TOME PRECISION INDUSTRY CO., LTD., Hakusan-shi (JP)

(21) Appl. No.: 18/756,383

(22) Filed: Jun. 27, 2024

Related U.S. Application Data
(63) Continuation of application No. PCT/JP2022/046334, filed on Dec. 16, 2022.

(30) Foreign Application Priority Data
Dec. 27, 2021 (JP) 2021-212203

(51) Int. Cl. B23Q 15/14; B23Q 17/22; G05B 19/404

(52) U.S. Cl. CPC B23Q 15/14; B23Q 17/2241; G05B 19/404

(57) ABSTRACT

An NC device for correcting a blade edge position at a time of a turning tool being mounted on a tool main spindle in a machine tool, comprising: first acquisition part for acquiring an inclination amount of a clamp surface of the tool main spindle; second acquisition part for acquiring a tool shaft rotation phase angle; third acquisition part for acquiring a protrusion amount in which the blade edge is protruded from the clamp surface of the tool main spindle; and first correction arithmetic processing part for arithmetically processing a deviation amount of the position of the blade edge that is generated between a reference position and the shaft rotation phase angle obtained by the second acquisition part due to the inclination amount of the tool clamp surface obtained by the first acquisition part and the protrusion amount obtained by the third acquisition part.

### CROSS REFERENCE TO RELATED APPLICATIONS

This application is a continuation of International Patent Application No. PCT/JP2022/046334, having an international filing date of Dec. 16, 2022, which designated the United States, the entirety of which is incorporated herein by reference. Japanese Patent Application No.2021-212203 filed on Dec. 27, 2021 is also incorporated herein by reference in its entirety.

### BACKGROUND OF THE INVENTION

In the field of NC-controlled machine tools such as composite processing machines, a tool main spindle on which both a rotary tool and a fixed tool can be mounted (clamped) is used. When a turning tool is mounted on the tool main spindle, the turning tool is set and fixed to a predetermined tool orientation angle (tool shaft rotation phase angle) and turning processing is executed, by an NC control program.

For example, Patent JP-A-2021-109274 discloses an art that detects whether a tool mounted on a tool main spindle is a turning tool, or a milling tool by an infrared sensor, executes rotation stop when it is detected that the tool is a turning tool, and corrects a displacement amount generated in the main spindle by a thrust that is applied to a piston clutch.

The art disclosed in the publication detects a blade edge by the infrared sensor, and does not perform correction control on an NC (Numerical Control) program.

### BRIEF DESCRIPTION OF THE DRAWINGS

FIG. 1 illustrates an example of a flowchart of machine processing using an automatic correction device (NC device) for a blade edge position according to the disclosure.

FIG. 2 illustrates an example of setting an inclination amount (angle) of a tool clamp surface.

FIG. 3 illustrates a state in which a tool (turning tool) is mounted on a tool main spindle.

FIG. 4A illustrates an explanatory diagram of a rotation radius of a tool when an inclination amount θ is plus, and FIG. 4B illustrates an explanatory diagram of a rotation radius of the tool when the inclination amount θ is minus.

FIG. 5A illustrates a correction amount of a deviation of a blade edge position from a reference when the inclination amount θ is plus, and FIG. 5B illustrates a correction amount of the deviation when the inclination amount θ is minus.

FIG. 6 illustrates an explanatory view of turning of the tool main spindle.

FIG. 7 illustrates a block diagram of an automatic correction device (NC device) and sensors.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

An object of the present disclosure is to provide an automatic correction device (NC device) and method for a blade edge position that can automatically correct a deviation of a tool blade edge from a reference position due to an inclination amount of the tool blade edge and an orientation angle when a turning tool is mounted on a tool main spindle in an NC-controlled machine tool.

An automatic correction device for a blade edge position according to the disclosure is an NC (Numerical Control) device for a blade edge position at a time of a turning tool being mounted on a tool main spindle in a machine tool, including first acquisition part for acquiring an inclination amount of a clamp surface of the tool main spindle;
second acquisition part for acquiring a tool shaft rotation phase angle;
third acquisition part for acquiring a protrusion amount in which the blade edge is protruded from the clamp surface of the tool main spindle;
first correction arithmetic processing part for arithmetically processing a deviation amount of the position of the blade edge that is generated between a reference position and the shaft rotation phase angle obtained by the second acquisition part due to the inclination amount of the tool clamp surface obtained by the first acquisition part and the protrusion amount obtained by the third acquisition part.

The tool clamp surface inclination amount herein refers to an inclination deviated by a predetermined angle with respect to an angle orthogonal to a mounting surface (clamp surface) where the turning tool is mounted on the tool main spindle.

When the blade edge of the tool has an inclination with respect to a mounting axis direction of the tool main spindle, a deviation from the reference position set to the processing program is generated in the position of the blade edge due to the protrusion amount of the blade edge and the tool shaft rotation phase angle due to indexing when the blade edge is oriented to a position in contact with a workpiece to be processed.

Thus, in the disclosure, the first correction arithmetic processing part is included so as to be able to automatically correct the deviation amount at a time of execution of turning processing.

The deviation amount of the blade edge position from the reference position also changes according to a turning angle of the tool main spindle.

Thus, in the disclosure, it is preferable to further have turning angle acquisition part for the tool main spindle and have second correction arithmetic processing part for a blade edge position based on a turning angle of the tool main spindle obtained by the turning angle acquisition part.

When the tool main spindle does not turn, only first correction arithmetic processing is executed, and when turning of the tool main spindle is involved, first and second correction arithmetic processing is executed.

Here, when a central axis of the tool spindle is defined as an X-axis and two orthogonal axes on a plane perpendicular to the X-axis are defined as a Y-axis and a Z-axis, the tool clamp surface inclination amount acquisition part acquires an amount of inclination of the clamping surface of the tool spindle in an XZ plane and/or an amount of inclination of the clamping surface of the tool spindle in an XY plane.

In the disclosure, a deviation amount of the blade edge position from a reference position at a time of orientation that is generated due to the inclination amount of the tool clamp surface and the tool protrusion amount is automatically corrected in an NC device.

Exemplary embodiments are described below. Note that the following exemplary embodiments do not in any way limit the scope of the content defined by the claims laid out herein. Note also that all of the elements described in the present embodiment should not necessarily be taken as essential elements

An automatic correction device for a blade edge position according to the disclosure, and an automatic correction method using the same will be described hereinafter based on the drawings, but the disclosure is not limited to this.

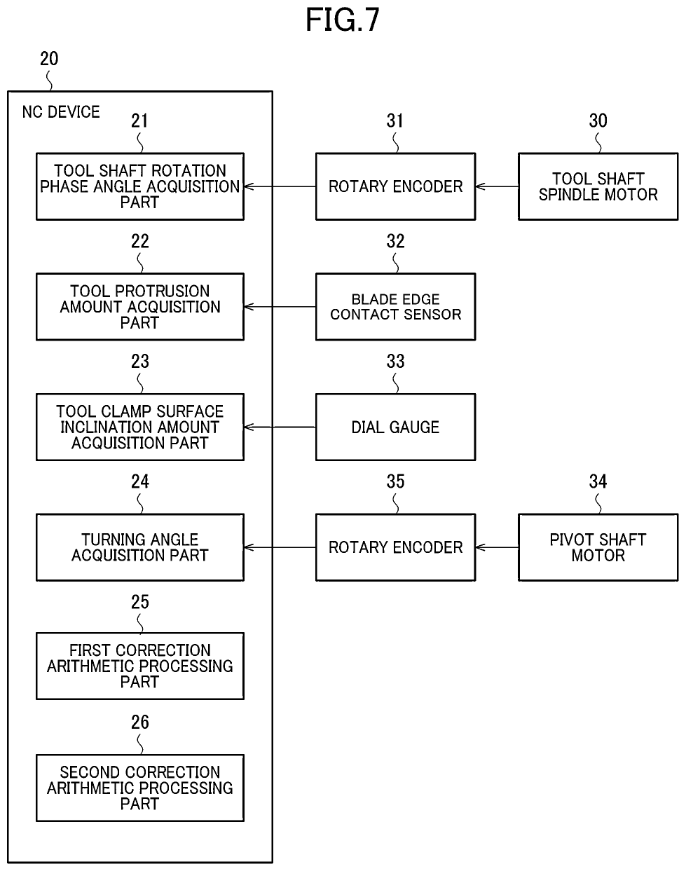

The automatic correction device for correcting the blade edge position is provided in the NC device 20 shown in FIG. 7. The NC device 20 includes a tool shaft rotation phase angle acquisition part (second acquisition part) 21, a tool protrusion amount acquisition part (third acquisition part) 22, a tool clamp surface inclination amount acquisition part (first acquisition part) 23, and a first correction arithmetic processing part 25. The NC device 20 may further include a turning angle acquisition part (fourth acquisition part) 24 and a second correction arithmetic processing part 26.

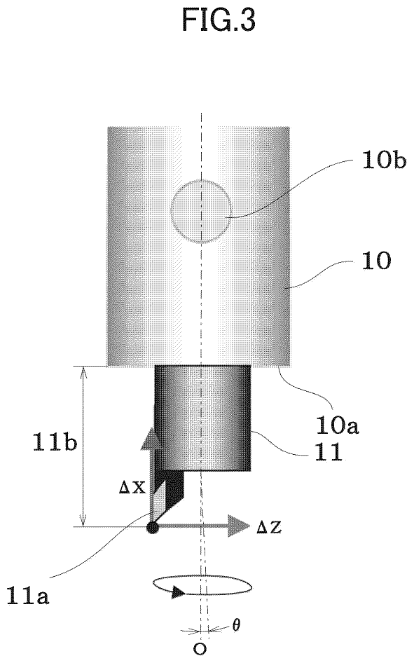

First, a state in which a tool (turning tool) 11 is mounted (clamped) on a tool main spindle 10 under rotational control will be described based on FIG. 3.

The present embodiment is an example of the tool main spindle 10 in which a turning axis 10b is subjected to turning control around a B-axis, a tool 11 mounted on this tool main spindle 10 is provided with a blade edge 11a for turning a workpiece during turning processing, and has a predetermined protrusion amount 11b from a mounting surface (clamp surface) 10a of the tool main spindle 10.

This protrusion amount is detected in advance by actual measurement using a measuring instrument such as a blade edge contact sensor 32 shown in FIG. 7, and is acquired by the tool protrusion amount acquisition unit (third acquisition unit) 22 of the NC device 20. The protrusion amount may be incorporated on a program as a tool offset value, and may be selectively acquired therefrom, for example.

Further, the blade edge 11a is disposed to be offset by a predetermined amount, and is disposed to be inclined by a predetermined inclination amount (angle), with respect to an axial center line O of the tool main spindle for a reason of turning quality or the like at a time of turning processing of the workpiece. The inclination amount is detected by actually measuring the mounting surface (clamping surface) 10a of the tool spindle 10 using a measuring device such as the dial gauge 33 shown in FIG. 7, and is acquired by the tool clamp surface inclination amount acquisition part (first acquisition part) 23 of the NC device 20.

Accordingly, when the blade edge 11a of the tool 11 is rotated and indexed with respect to the workpiece at the time of turning processing, a deviation from a reference position occurs at a position of the blade edge 11a.

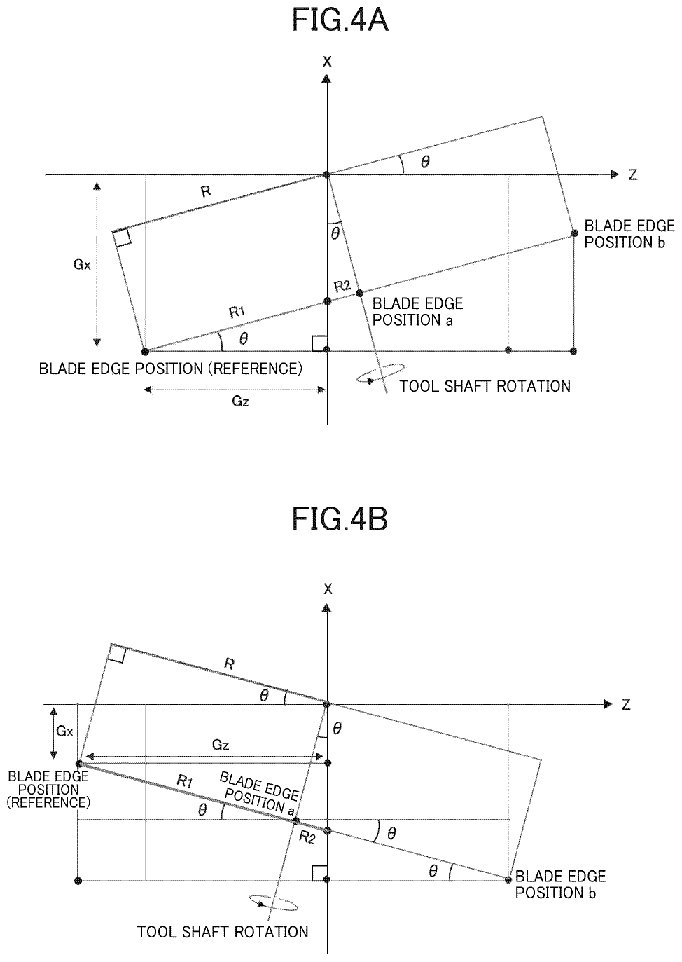

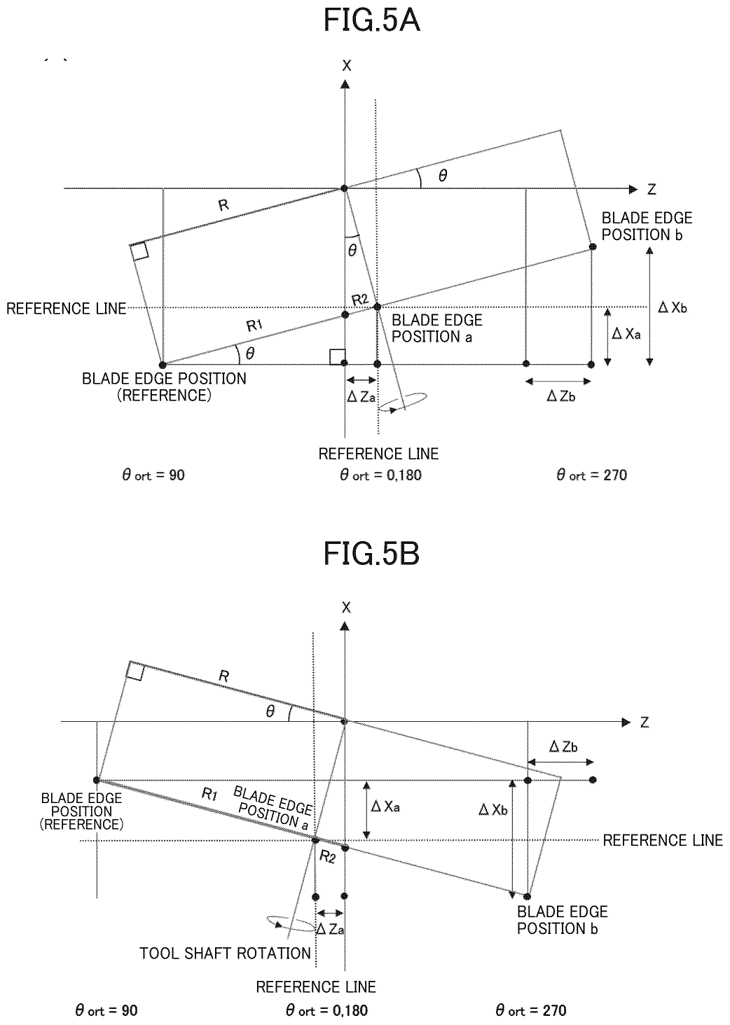

A content thereof will be described in FIG. 4 and FIG. 5.

FIG. 4 illustrates explanatory diagrams for obtaining a rotation radius associated with orientation of the tool 11, FIG. 4A is explanation of a case where an inclination amount (angle) θ is plus, and FIG. 4B is explanation of the case where it is minus.

Reference signs illustrated in FIG. 4 are as follows.
R: rotation radius of blade edge
θ: Inclination amount (angle) in XZ plane
Gx: X-axis direction protrusion amount
Gz: Z-axis direction protrusion amount

Here, the central axis of the tool spindle 10 is defined as the X-axis, and two orthogonal axes on a plane perpendicular to the X-axis are defined as the Y-axis and the Z-axis.

When defined in this manner, there are relationships shown in Expressions (1) to (3) below.

$$R = {R}_{1} + {R}_{2} \qquad ( 1 )$$

$${R}_{1} = \frac{G z}{cos θ} \qquad ( 2 )$$

$${R}_{2} = [ Gx - Gz tan θ ] \cdot sin θ \qquad ( 3 )$$

The rotation radius R of the blade edge is obtained by Expression (1), R¹ is obtained by expression (2), and R₂ is obtained by expression (3).

Subsequently, correction amounts of deviations when the blade edge position is indexed from the reference position to, for example, blade edge positions “a” and “b” respectively by rotation of the tool will be described based on FIG. 5.

FIG. 5A illustrates a case in which θ is plus, and FIG. 5B illustrates a case in which θ is minus.

When a tool shaft rotation phase angle is (θ_{ORT}), a correction amount ΔX in an X-axis direction due to this is obtained by Expression (4) below from a relationship illustrated in FIG. 5. Note that, as shown in FIG. 7, the tool shaft rotation phase angle (θ_{ORT}) is obtained by detecting the phase angle of the tool shaft spindle motor 30 by the rotary encoder 31, and is acquired by the tool shaft rotation phase angle acquisition part (second acquisition part) 21 of the NC device 20.

$$Δ X = R sin θ - R sin θ \cdot sin {θ}_{ort} \qquad ( 4 )$$

Further, a correction amount ΔZ in a Z-axis direction is obtained by Expression (5) below.

$$Δ Z = {R}_{2} cos θ - {R}_{2} cos θ \cdot sin {θ}_{ort} \qquad ( 5 )$$

Note that a correction amount ΔY in a Y-axis direction can also be similarly obtained from an inclination amount (angle) in XY plane etc. although not illustrated.

Arithmetic processing based on the expressions shown in Expressions (1) to (5) described above is referred to as first correction arithmetic processing, and is processed by the first correction arithmetic processing part 25 shown in FIG. 7.

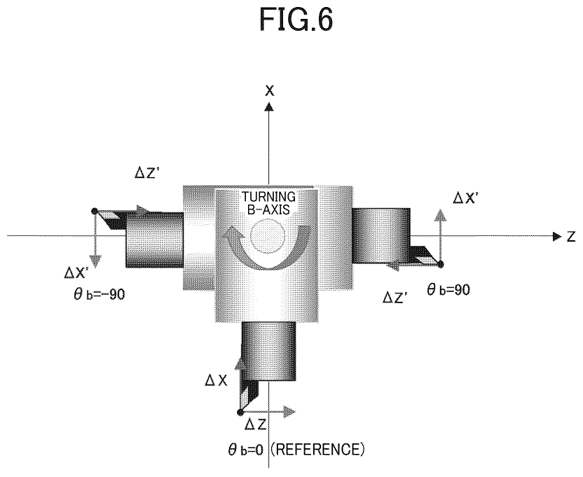

FIG. 6 is a case in which turning of the tool main spindle is controlled around the B-axis in the present embodiment, and when a turning B-axis angle detected by a rotary encoder 35 provided in the pivot shaft motor 34 shown in FIG. 7 is θ_{P}, the turning B-axis angle θ_{P} is acquired by the turning angle acquisition part (fourth acquisition part) 24 of the NC device 20. A correction amount ΔX′ in the X-axis direction is obtained by Expression (6) below.

$$Δ {X}^{′} = Δ X cos {θ}_{b} + Δ Z sin {θ}_{b} \qquad ( 6 )$$

Further, a correction amount ΔZ′ in the Z-axis direction is obtained by Expression (7) below.

$$Δ {Z}^{′} = - Δ X sin {θ}_{b} + Δ Z cos {θ}_{b} \qquad ( 7 )$$

Arithmetic processing based on Expressions (6) and (7) described above is referred to as second correction arithmetic processing, and is processed by the second correction arithmetic processing part 26 shown in FIG. 7.

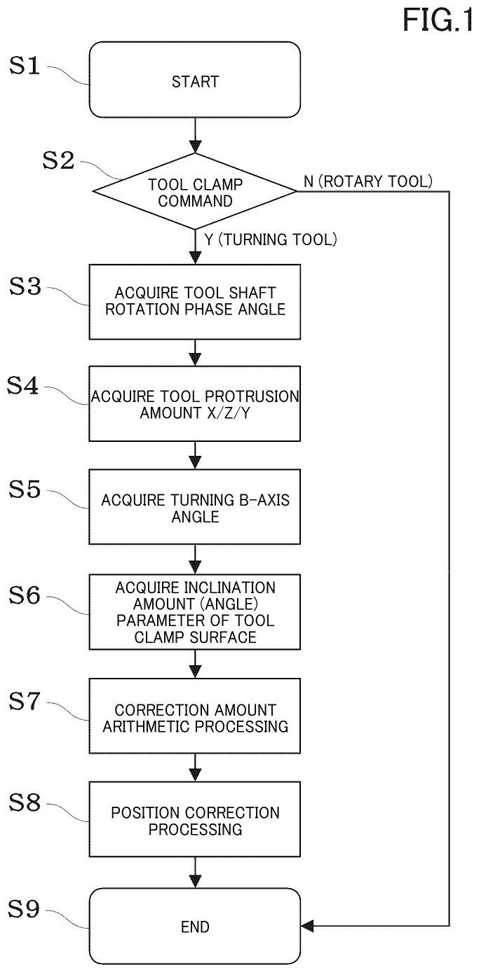

FIG. 1 illustrates an example of a flowchart of turning processing using an automatic correction device for a blade edge position according to the disclosure.

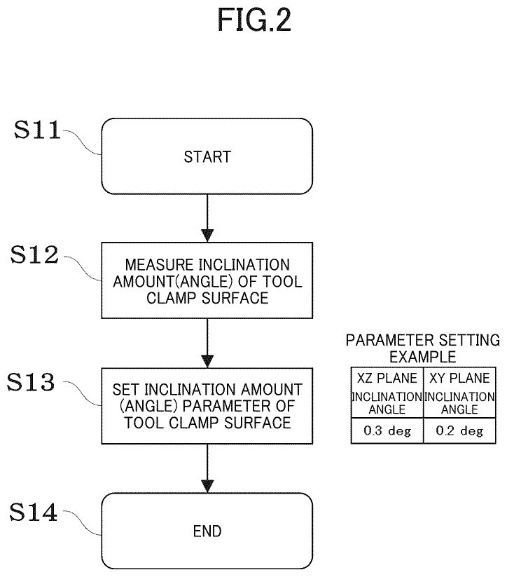

In this case, as illustrated in FIG. 2, it is preferable to set a parameter of an inclination amount (angle) of a tool clamp surface as preparation in advance.

When a start designation (S11) is issued in an NC device 20, the inclination amount of the tool clamp surface is automatically measured by the dial gauge 33 (S12), a parameter of the inclination amount of the tool clamp surface is set (S13) to complete the process (S14).

When a start command (S1) is issued in the NC device 20, a tool is mounted on the tool main spindle 10 based on a clamp command (S2).

When the tool clamped at this point of time is a rotary tool, a correction processing for the blade edge position ends, and processing by the rotary tool is executed.

Further, when the tool is a turning tool, the process proceeds to a next step.

An orientation angle is acquired by tool shaft rotation phase angle acquisition part 21 (S3), and then protrusion amounts in the X-axis, Z-axis and Y-axis are acquired by tool protrusion amount acquisition part 22 (S4).

Subsequently, the turning B-axis angle of the tool main spindle (10) is acquired by turning angle acquisition part 24 as necessary (S5).

Subsequently, a parameter of the inclination amount of the tool clamp surface described in FIG. 2 is acquired by the tool clamp surface inclination amount acquisition part 23 (S6).

Based on data acquired from these, the correction amount is arithmetically processed by the first and second correction arithmetic processing part 25, 26 according to Expressions (1) to (7) described above (S7).

Based on an arithmetic processing result, the deviation amount of the blade edge position from the reference position is corrected (S8) to complete the process.

Turning processing is executed while repeating this.

The disclosure can be applied to various machine tools in which rotary tools such as milling tools, fixed tools such as turning tools, or the like are selectively mounted on tool main spindles such as composite machines.

The present embodiment shows the example of the tool main spindle that is positionally controlled in the X-axis direction, Z-axis direction, and the Y-axis direction with a workpiece held on the main spindle under rotational control, and the tool main spindle is subjected to turning control around the B-axis.

The main spindle may be main spindles disposed to face each other in a twin-main-spindle facing lathe.

### INDUSTRIAL APPLICABILITY

The disclosure can be used in various machine tools since the deviation amount of the blade edge position from the reference position can be automatically corrected in the NC device.

Although only some embodiments of the present disclosure have been described in detail above, those skilled in the art will readily appreciate that many modifications are possible in the embodiments without materially departing from the novel teachings and advantages of this disclosure. Accordingly, all such modifications are intended to be included within scope of this disclosure.

1. An NC device for correcting a blade edge position at a time of a turning tool being mounted on a tool main spindle in a machine tool, comprising:
first acquisition part for acquiring an inclination amount of a clamp surface of the tool main spindle;
second acquisition part for acquiring a tool shaft rotation phase angle;
third acquisition part for acquiring a protrusion amount in which the blade edge is protruded from the clamp surface of the tool main spindle; and
first correction arithmetic processing part for arithmetically processing a deviation amount of the position of the blade edge that is generated between a reference position and the shaft rotation phase angle obtained by the second acquisition part due to the inclination amount of the tool clamp surface obtained by the first acquisition part and the protrusion amount obtained by the third acquisition part.

2. The NC device for correcting a blade edge position according to claim 1, further comprising:
fourth acquisition part for acquiring a turning angle of the tool main spindle, and
second correction arithmetic processing part for arithmetically processing a deviation amount of the blade edge based on the turning angle of the tool main spindle obtained by the fourth acquisition part.

3. The NC device for correcting a blade edge position according to claim 1, wherein, wherein, when a central axis of the tool spindle is defined as an X-axis and two orthogonal axes on a plane perpendicular to the X-axis are defined as a Y-axis and a Z-axis, the first acquisition part acquires an amount of inclination of the clamping surface of the tool spindle in an XZ plane and/or an amount of inclination of the clamping surface of the tool spindle in an XY plane.

4. The NC device for correcting a blade edge position according to claim 2, wherein, when a central axis of the tool spindle is defined as an X-axis and two orthogonal axes on a plane perpendicular to the X-axis are defined as a Y-axis and a Z-axis, the first acquisition part acquires an amount of inclination of the clamping surface of the tool spindle in an XZ plane and/or an amount of inclination of the clamping surface of the tool spindle in an XY plane.

5. An automatic correction method for correcting a position of a blade edge of a turning tool at a time of the turning tool being mounted on a tool main spindle in a machine tool, comprising:
first acquisition step in which an NC device acquires an inclination amount of a clamp surface of the tool main spindle;
second acquisition step in which the NC device acquires a tool shaft rotation phase angle;
third acquisition step in which the NC device acquires a protrusion amount in which the blade edge is protruded from the clamp surface of the tool main spindle; and
first correction arithmetic processing step in which the NC device arithmetically processes a deviation amount of the position of the blade edge that is generated between a reference position—and the shaft rotation phase angle obtained by the second acquisition step due to the inclination amount of the tool clamp surface obtained by the first acquisition step and the protrusion amount obtained by the third-acquisition step.

6. The automatic correction method for a blade edge position according to claim 5, further comprising:
fourth acquisition step in which the NC device acquires a turning angle of the tool main spindle, and
second correction arithmetic processing step in which the NC device arithmetically processes a deviation amount of the blade edge based on the turning angle of the tool main spindle obtained by the fourth acquisition step.
